(19) United States
(12) Patent Application Publication
(10) Pub. No.: US 2006/0280857 A1
(43) Pub. Date: Dec. 14, 2006

(54) Fat and oil composition

(75) Inventors: Junichi Ikuina, Yokosuka-shi (JP); Kazuma Yoshimura, Yokosuka-shi (JP)

Correspondence Address: BUCHANAN, INGERSOLL & ROONEY PC, POST OFFICE BOX 1404, ALEXANDRIA, VA, 22313-1404, US

(73) Assignee: The Nisshin OilliO Group, Ltd., Tokyo (JP)

(21) Appl. No.: 11/498,154

(22) Filed: Aug. 3, 2006

Related U.S. Application Data
(63) Continuation of application No. PCT/JP05/01772, filed on Feb. 7, 2005.

(30) Foreign Application Priority Data
Feb. 6, 2004 (JP) 2004-030510

(51) Int. Cl. A23D 7/00

(52) U.S. Cl. 426/611

(57) ABSTRACT

It is an object of the present invention to provide a fat and oil composition, which permits the control of the amount of the oil absorbed by a subject to be cooked during cooking the same through heating, which is excellent in the cooking properties and has satisfactory taste and flavor and which can control the amount of the fats and oils taken by the body. The present invention thus herein provides a fat and oil composition comprising triglycerides as a principal component and 0.1 to 9.5% by mass of sucrose fatty acid esters, which esters have an average degree of substitution ranging from 5 to 7, a content of the polyesters having 3 or more present in the ester of not less than 85% by mass, a content of the monoesters present therein of not more than 5% by mass and a content of the diesters present therein of not more than 10% by mass on the basis of the total mass of the sucrose fatty acid esters.

### TECHNICAL FIELD

The present invention relates to a fat and oil composition for fry-cooking. More specifically, the present invention pertains to a fat and oil composition for fry-cooking, which comprises sucrose fatty acid esters and which can control the oil absorption of a subject to be cooked.

### BACKGROUND ART

As the fats and oils for use in cooking through heating such as those used in fry-cooking, there have conventionally been used, for instance, soybean oil, rapeseed oil, corn oil, cotton seed oil, rice oil, safflower oil, sunflower oil, sesame oil, olive oil, coconut oil, palm oil, lard, and modified oils derived therefrom (oils processed by transesterification, hydrogenated oils), which may be used alone or in any mixture thereof.

The fats and oils for fry-cooking have mainly been used for the purpose of preventing any scorching of a subject to be fried. However, the use of fats and oils in a large quantity would result in an increase in the amount thereof soaked into the subject to be cooked and this accordingly leads to the formation of an extremely oily fried product and the reduction of the taste and flavor peculiar to the subject to be cooked. In addition, the recent excess caloric intake has become a problem and it is accordingly desirable that the amount of fats and oils to be used should be reduced for the maintenance of good health.

For this reason, there has been desired for the development of fats and oils which can surely prevent the occurrence of any scorching even when using the same in a small amount and which can ensure excellent cooking of various subjects, while taking into consideration even the taste of the resulting fried products and the health of the users.

There has been proposed an oil which is improved in the amount of the oil absorbed by a subject to be fried, which comprises a sucrose fatty acid ester mixture and in which the sucrose fatty acid ester mixture has a content of the monoesters of less than 50% by mass and a content of the triesters of not less than 15% by mass, on the basis of the total sucrose fatty acid esters present in the ester mixture (the total amount of the diesters, tri-esters and tetra-esters included in the sucrose fatty acid ester mixture is greater than 50% by mass on the basis of the total mass of the esters present in the fatty acid ester mixture) (see, for instance, Patent Document 1 specified below), but this technique would still be insufficient in the reduction of the oil absorption.

Patent Document 1: Japanese Un-Examined Patent Publication Hei 7-147902

### DISCLOSURE OF THE INVENTION

### Problems that the Invention is to Solve

It is an object of the present invention to provide a fat and oil composition for fry-cooking, which can control the oil absorption of a subject to be cooked when frying the same and which can impart good taste and flavor to the resulting cooked product.

### Means for Solving the Problems

The inventors of this invention have conducted various studies to solve the foregoing problems, have found that the oil absorption of fats and oils for cooking through heating such as those for fry-cooking can be improved by the incorporation of sucrose fatty acid esters into a fat and oil composition for fry-cooking and have thus completed the present invention.

According to the present invention, there is thus provided a fat and oil composition for fry-cooking, which comprises triglyceride as a principal component and 0.1 to 9.5% by mass of sucrose fatty acid esters, which esters have an average degree of substitution ranging from 5 to 7, a content of the polyesters having 3 or more ester bonds present in the sucrose fatty acid esters of not less than 85% by mass, a content of the monoesters present therein of not more than 5% by mass and a content of the diesters present therein of not more than 10% by mass on the basis of the total mass of the sucrose fatty acid esters.

### Effects of the Invention

The composition of the present invention permits the reduction of the oil absorption of a subject to be cooked and this in turn permits the cooking of the subject while using a small amount of fats and oils. In addition, the ability of the composition of the invention to cook a subject is not changed at all, although the fats and oils are used in a reduced amount. As a result, the present invention herein provides a fat and oil composition which is excellent in the taste and flavor, which permits the reduction of the amount thereof to be used and which can control the amount of the fats and oils taken by the body.

### BEST MODE FOR CARRYING OUT THE INVENTION

The fat and oil composition of the present invention comprises triglycerides as a principal component. The term “as a principal component” used herein means that the triglycerides are present in the composition in an amount of not less than 50% by mass, preferably not less than 60% by mass and more preferably not less than 70% by mass, while the total amount of the diglycerides and monoglycerides as the components other than the triglycerides is less than 50% by mass, preferably less than 40% by mass and more preferably less than 30% by mass. Further, the term likewise means that the composition includes not more than 10% by mass, preferably not more than 7% by mass and more preferably not more than 5% by mass of non-glyceride components as impurities, for instance, un-saponified components usually contained in the fats and oils such as glycerin, sterols and tocopherols, and food additives such as an emulsifying agent and an antioxidant.

Glycerides mainly comprising triglycerides may be, for instance, the usual edible oils, oils processed by transesterification-treatments, ester derivatives of glycerin, and raw materials for fats and oils such as hydrolyzates of the foregoing materials. Examples of such raw materials for fats and oils include soybean oil, rapeseed oil, corn oil, sesame oil, sesame-salad oil, Shiso oil, linseed oil, peanut oil, safflower oil, oleic acid-rich safflower oil, sunflower oil, oleic acid-rich sunflower oil, cotton seed oil, grape seed oil, macadamia nut oil, hazel nut oil, pumpkin seed oil, walnut oil, camellia oil, tea (shrub) seed oil, perilla oil, borage oil, olive oil, rice oil, wheat germ oil, palm oil, palm kernel oil, coconut oil, cacao oil, beef tallow, lard, chicken fat, milk fat, fish oil (marine oil), seal fat, seaweed oil, middle chain fatty acid triglycerides, those fats and oils whose degree of saturation is reduced by the animal and plant breeding and hydrogenated fats and oils derived from the foregoing, and fractionated fats and oils, but the present invention is not restricted to these specific ones at all. Examples of the raw materials for fats and oils preferably used herein are vegetable oils such as soybean oil, rapeseed oil, sunflower oil, safflower oil, linseed oil, palm oil, rice oil and corn oil; middle chain fatty acid triglycerides (having 6 to 12 and preferably 8 to 10 carbon atoms); or mixed oils thereof; hydrogenated oils; fractionated oils; oils subjected to transesterification-treatments.

The fat and oil composition of the present invention comprises sucrose fatty acid esters in addition to the triglyceride as the principal component. The sucrose fatty acid esters used in the present invention is present in the fat and oil composition in an amount ranging from 0.1 to 9.5% by mass. Preferably, in the light of cooking, the fat and oil composition comprises 0.5 to 2% by mass of the sucrose fatty acid esters. It is more preferred that the composition comprises the fatty acid esters in an amount ranging from 0.6 to 1.5% by mass. Moreover, the sucrose fatty acid esters preferably has an average degree of substitution ranging from 5 to 7. The term “average degree of substitution” herein used means the average of the degree of esterification of the sucrose fatty acid esters and more specifically a calculated average number of ester bonds per molecule. Further, the sucrose fatty acid esters used herein should include the polyesters having 3 or more ester bonds in all on the order of not less than 85% by mass, preferably not less than 90% by mass, more preferably not less than 93% by mass and most preferably not less than 94% by mass on the basis of the mass of the whole sucrose fatty acid esters present therein. The monoesters and diesters are preferably present in a low rate, while the sum of the triesters, tetraesters, penta-esters, hexa-esters, hepta-esters should preferably be present in a high rate, from the viewpoint of the ability to inhibit the oil absorption of a subject to be cooked. In particular, an excellent oil absorption-inhibitory effect can be expected when incorporating, into the fat and oil composition for fry-cooking, sucrose fatty acid esters having a content of the monoesters of not more than 5% by mass, preferably not more than 3% by mass, more preferably not more than 2% by mass and most preferably not more than 1% by mass, and a content of the diesters of not more than 10% by mass, preferably not more than 7% by mass and more preferably not more than 5% by mass. Moreover, to achieve a more improved oil absorption-inhibitory effect, it would be suitable for the sucrose fatty acid ester to satisfy the following requirement: the total amount of the tetraesters, penta-esters, hexa-esters, hepta-esters should be not less than 60% by mass, preferably not less than 70% by mass and more preferably not less than 75% by mass, while the sucrose fatty acid esters have the contents of the monoesters and the diesters falling within the ranges each specified above. Incidentally, the HLB values of the whole sucrose fatty acid esters should be not less than 0 and less than 3 from the viewpoint of the desired oil absorption-inhibitory effect. The HLB value is the numerical value representing the balance between the hydrophobicity and hydrophilicity of a surfactant and can be determined according to the method disclosed in, for instance, “Emulsifying Agents for Foods . . . Fundamentals and Applications ...” (Yoshio TODA et al., Published by KORIN Publishing Company), p. 13.

The aliphatic carboxylic acids constituting the sucrose fatty acid esters usable herein include, for instance, aliphatic carboxylic acids having 2 to 22, preferably 8 to 22 and more preferably 14 to 22 carbon atoms such as linear saturated aliphatic carboxylic acids, linear unsaturated aliphatic carboxylic acids, and branched saturated aliphatic carboxylic acids. Specific examples thereof include, but are not limited to caproic acid, caprylic acid, capric acid, lauric acid, myristic acid, palmitic acid, stearic acid, arachidic acid, behenic acid, lignoceric acid, cerotic acid (hexacosanoic acid), palmitoleic acid, oleic acid, elaidic acid, linolic acid, linolenic acid, eicosapentaenoic acid, docosahexaenoic acid, arachidonic acid, erucic acid, acetic acid and isobutyric acid. Preferably used herein include, for instance, palmitic acid, stearic acid, oleic acid, linolic acid, linolenic acid and erucic acid. When the fat and oil composition is in the form of a liquid oil, the aliphatic carboxylic acids are preferably unsaturated aliphatic carboxylic acids having 16 to 22 carbon atoms for ensuring the ability of maintaining the precipitated state and a desired turbidity at a low temperature. Specific examples thereof are oleic acid, linolic acid, linolenic acid and erucic acid.

In addition, it is preferred in the present invention that the aliphatic carboxylic acids constituting the sucrose fatty acid esters comprise 0.1 to 50% by mass of saturated carboxylic acids having 16 to 18 carbon atoms and 50 to 99.9% by mass of unsaturated carboxylic acids having 18 to 22 carbon atoms. In this respect, the foregoing unsaturated carboxylic acid is preferably one having 1 to 3 double bonds in the molecule.

Furthermore, it is preferred for the fat and oil composition according to the present invention to use the sucrose fatty acid esters which comprises sucrose fatty acid esters comprising unsaturated carboxylic acids in an amount of not less than 70% by mass, preferably not less than 80% by mass and more preferably not less than 85% by mass of the total aliphatic carboxylic acids constituting the sucrose fatty acid esters; and sucrose fatty acid esters comprising saturated aliphatic carboxylic acids in an amount ranging from 40 to 80% by mass, preferably 40 to 60% by mass and more preferably 45 to 55% by mass of the total aliphatic carboxylic acid constituting the sucrose fatty acid esters, while taking into consideration the low temperature resistance of the resulting composition because the suppression of any crystallization of the fats and oils at a low temperature. More preferably used herein are those in which the rate of the sucrose fatty acid esters comprising saturated aliphatic carboxylic acids in an amount ranging from 40 to 80% by mass, preferably 40 to 60% by mass and more preferably 45 to 55% by mass of the total aliphatic carboxylic acids constituting the sucrose fatty acid esters ranges from 1 to 20% by mass, preferably 5 to 20% by mass and more preferably 5 to 10% by mass on the basis of the mass of the total sucrose fatty acid esters. In this respect, the foregoing unsaturated aliphatic carboxylic acid likewise preferably has 1 to 3 double bonds in the molecule.

The fat and oil composition of the present invention prepared by the foregoing method may be used without any post-treatment, but may likewise be used after the addition of other additives commonly used in the usual fats and oils for fry-cooking. Examples of such usual additives are an antioxidant such as tocopherol, an ascorbic acid ester, TBHQ and BHT; a stabilizing agent such as phosphoric acid and citric acid; an emulsifying agent such as a glycerin fatty acid ester, an organic acid monoglyceride, a polyglycerin fatty acid ester, a polyglycerin-condensed ricinolic acid ester, a sorbitan fatty acid ester, a sorbitol fatty acid ester, a propylene glycol fatty acid ester, a sucrose fatty acid ester and polysorbate; and an oil-soluble component such as a carotene, phytosterol and a phytosterol ester, but the kinds and the amounts thereof to be incorporated into the fat and oil composition are not restricted to specific ranges at all.

The fat and oil composition according to the present invention possesses the taste and flavor almost identical to or superior to those observed for the usual vegetable oils commonly put on the market such as rapeseed oil, corn oil, safflower oil and soybean oil.

The present invention will now be described in more detail with reference to the following Examples, but the present invention is not restricted to these specific Examples at all.

### EXAMPLES

<Sucrose Fatty Acid Ester>

Products available from Mitsubishi Chemical Foods Co., Ltd. under the trade name of RYOTO SUGAR ESTER (O-170, ER-190, S-370 and POS-135) were used in the following test. The following Table 1 shows the results obtained by inspecting these sucrose fatty acid ester products for the compositions thereof (the aliphatic carboxylic acids formed through the hydrolysis of each product were analyzed by the gas chromatography technique), the HLB values and the average degrees of substitution.

TABLE 1

| | | | |
|---|---|---|---|
| O-170 | ER-190 | S-370 | POS-135 |

Composition of Principal Aliphatic Carboxylic Acids

| | | | | |
|---|---|---|---|---|
| Palmitic acid | | | 28 | 28 |
| Stearic acid | 2 | | 70 | 23 |
| Oleic acid | 77 | | | 39 |
| Linoleic acid | 13 | | | 7 |
| Erucic acid | | 92 | 1 | |
| Average Degree of Substitution | 5.6 | 5.7 | 2.6 | 5.2 |
| HLB Value | 1 | 1 | 3 | 1 |

Composition

| | | | | |
|---|---|---|---|---|
| Monoesters | 0.0 | 0.1 | 17.7 | 0.0 |
| Diesters | 1.0 | 2.3 | 33.1 | 3.0 |
| Triesters | 8.6 | 8.9 | 29.6 | 10.1 |
| Tetraesters | 14.7 | 12.3 | 14.8 | 16.9 |
| Penta-esters | 20.8 | 16.0 | 4.8 | 25.2 |
| Hexa-esters | 26.8 | 24.9 | 0.0 | 30.1 |
| Hepta-esters | 19.9 | 23.9 | 0.0 | 12.0 |
| Octa-esters | 8.2 | 11.6 | 0.0 | 2.7 |
| Acid Value | 2.7 | 2.5 | 3.4 | 3.3 |

<Composition of Samples>

The fats and oils used in the following oil absorption test have the following compositions specified in the following Tables 2 and 3:

TABLE 2
Compositions of Fats and Oils

| | O-170 | ER-190 | S-370 | Soybean Oil |
|---|---|---|---|---|
| Sample A | 0.1 | 0 | 0 | 99.9 |
| Sample B | 0.5 | 0 | 0 | 99.5 |
| Sample C | 1 | 0 | 0 | 99 |
| Sample D | 2 | 0 | 0 | 98 |
| Sample E | 4 | 0 | 0 | 96 |
| Sample F | 10 | 0 | 0 | 90 |
| Sample G | 0 | 0.1 | 0 | 99.9 |
| Sample H | 0 | 0.5 | 0 | 99.5 |
| Sample I | 0 | 1 | 0 | 99 |
| Sample J | 0 | 2 | 0 | 98 |
| Sample K | 0 | 4 | 0 | 96 |
| Sample L | 0 | 10 | 0 | 90 |
| Sample M | 0 | 0 | 0.1 | 99.9 |
| Sample N | 0 | 0 | 0.5 | 99.5 |
| Sample O | 0 | 0 | 1 | 99 |
| Sample P | 0 | 0 | 2 | 98 |
| Sample Q | 0 | 0 | 4 | 96 |
| Sample R | 0 | 0 | 10 | 90 |
| Sample S | 0 | 0 | 0 | 100 |

TABLE 3
Compositions of Fats and Oils

| | MLCT* | O-170 | POS-135 | Antioxidant |
|---|---|---|---|---|
| Sample a | 99.9 | 0.09 | 0.01 | |
| Sample b | 99.5 | 0.4 | 0.1 | |
| Sample c | 99.1 | 0.85 | 0.05 | |
| Sample d | 90 | 9.5 | 0.5 | |
| Sample e | 100 | 0 | 0 | |
| Sample f | 99.5 | 0.4 | 0.1 | TBHQ 10 ppm |
| Sample g | 99.1 | 0.85 | 0.05 | Tocopherol 100 ppm |

*MLCT: An oil comprising 86% by mass of rapeseed oil and 14% by mass of a middle chain fatty acid triglyceride and subjected to transesterification treatment.

In this Example, the “middle chain fatty acid triglyceride” used means one comprising octanoic acid and decanoic acid (in a mass ratio of 75:25) as the constituent fatty acids.

<Oil Absorption Test>

A garden egg was cut in round slices and one side of each slice thereof was immersed in an oil for 10 minutes to thus evaluate the oil absorption thereof. The oil absorption was determined in such a manner that the round slice of the garden egg was allowed to stand in the oil for 10 minutes and the change in the mass thereof was determined to thus calculate the rate of oil absorbed by the slice (Oil Absorption Rate).

TABLE 4
Oil Absorption Rate of Garden Egg and Comparison Different Samples

| | | Oil Absorption Rate |
|---|---|---|
| Example | Sample A | 33.4 |
| | Sample B | 25.3 |
| | Sample C | 19.4 |
| | Sample D | 6.4 |
| | Sample E | 4.8 |
| | Sample G | 35.6 |
| | Sample H | 25.8 |
| | Sample I | 20.9 |
| | Sample J | 5.3 |
| | Sample K | 4.8 |
| Comparative | Sample F | 4.3 |
| Example | Sample L | 4.3 |
| | Sample M | 46.1 |
| | Sample N | 43.4 |
| | Sample O | 37.1 |
| | Sample P | 26.1 |
| | Sample Q | 23.8 |
| | Sample R | 19.8 |
| | Sample S | 46.0 |

<Fry-Cooking Test 1>

To a frying pan for domestic use, there was added 30 g of fats and oils, followed by frying garden egg slices and an egg in order to inspect the fats and oils for the taste and flavor and the occurrence of fuming.

Ten panelists were requested to evaluate these properties of the fats and oils. In this connection, the oil absorption rate was calculated on the basis of the following relation:
Oil Absorption Rate (%)=[(Amt. of Oil Used in Exp.)−(Amt. Thereof Remaining After the Exp.)]/(Amt. of Oil Used in Exp.)
(Evaluation of Taste and Flavor)
⊚: Simple or plain taste;
◯: Rather simple or plain; and
Δ: Rich or heavy taste;
   (Occurrence of Fuming)
◯: Free of any fuming; and

X: There was observed slight fuming.

TABLE 5
Composition and Results of Taste and Flavor Evaluation

| | | Garden Egg | Egg roll | Fuming |
|---|---|---|---|---|
| Example | Sample C | ⊚ | ⊚ | ◯ |
| | Oil Absorption Rate | 3% | 2.5% | |
| | Sample I | ⊚ | ⊚ | ◯ |
| | Oil Absorption Rate | 3% | 2.5% | |
| Comparative | Sample F | ⊚ | ⊚ | X |
| Example | Oil Absorption Rate | 2.5% | 2% | |
| | Sample L | ⊚ | ⊚ | X |
| | Oil Absorption Rate | 2.5% | 2.5% | |
| | Sample O | ◯ | ◯ | ◯ |
| | Oil Absorption Rate | 4% | 4% | |
| | Sample R | ◯ | ◯ | X |
| | Oil Absorption Rate | 3% | 3% | |
| | Sample S | Δ | Δ | ◯ |
| | Oil Absorption Rate | 6% | 5% | |

The use of O-170 or ER-190 as the sucrose fatty acid esters would permit the reduction of the amount of oils soaked into the subject to be cooked and can provide a cooked product having simple or plain taste and flavor as compared with the results obtained using S-370 as the sucrose fatty acid esters. In addition, when the amount of the sucrose fatty acid esters used was not less than 10% by mass, irrespective of the kind of the emulsifying agent used, there was observed the occurrence of fuming during cooking and accordingly, such fats and oils were found to have unacceptable cooking properties.

<Fry-Cooking Test 2>

To a frying pan for domestic use, there was added 30 g of fats and oils, followed by frying a garden egg and an egg in order to inspect the fats and oils for the taste and flavor and the occurrence of fuming. Ten panelists were requested to evaluate these properties of the fats and oils. In this connection, the oil absorption rate was calculated on the basis of the following relation:
Oil Absorption Rate (%)=[(Amt. of Oil Used in Exp.)−(Amt. Thereof Remaining After the Exp.)]/(Amt. of Oil Used in Exp.)

In addition, the low temperature resistance of the fats and oils was evaluated by airtightly sealing the fats and oils in a bottle, storing the bottle at 0° C. for 2 weeks and then visually observing the stored fats and oils contained in the bottle.

(Evaluation of Taste and Flavor)

⊚: Simple or plain taste;
◯: Rather simple or plain; and
Δ: Rich or heavy taste;
   (Occurrence of Fuming)
◯: Free of any fuming; and
X: There was observed slight fuming.
   <Evaluation of Low Temperature Resistance>
⊚: Transparent;
◯: There was observed slight blurring (but acceptable level); and

X: The fats and oils got cloudy.

TABLE 6
Composition and Results of Taste and Flavor Evaluation

| | | | | | Low |
|---|---|---|---|---|---|
| | | Garden | Egg | | Temp. |
| | | Egg | Roll | Fuming | Res. |
| Example | Sample a | ⊚ | ⊚ | ◯ | ⊚ |
| | Oil Absorption Rate | 5.2% | 5.0% | | |
| | Sample b | ⊚ | ⊚ | ◯ | ⊚ |
| | Oil Absorption Rate | 3.2% | 3.4% | | |
| | Sample c | ⊚ | ⊚ | ◯ | ⊚ |
| | Oil Absorption Rate | 2.6% | 2.7% | | |
| | Sample f | ⊚ | ⊚ | ◯ | ⊚ |
| | Oil Absorption Rate | 3.0% | 3.2% | | |
| | Sample g | ⊚ | ⊚ | ◯ | ⊚ |
| | Oil Absorption Rate | 2.8% | 2.5% | | |
| Comparative | Sample d | ⊚ | ⊚ | X | ◯ |
| Example | Oil Absorption Rate | 2.5% | 2.5% | | |
| | Sample e | ◯ | ◯ | ◯ | X |
| | Oil Absorption Rate | 6% | 6% | | |

It was found that the fat and oil composition containing sucrose fatty acid esters permitted the reduction of the amount of oils soaked into the subject to be cooked and could provide a cooked product having simple or plain taste and flavor as compared with the results observed for the fat and oil composition free of any sucrose fatty acid esters. In addition, when the amount of the sucrose fatty acid esters used was not less than 10% by mass, there was observed the occurrence of fuming during cooking and accordingly, such fats and oils were found to have unacceptable cooking properties. Moreover, it was found that the example of the fat and oil composition according to the present invention which made use of POS-135 as the sucrose fatty acid esters showed excellent low temperature resistance.

What is claimed is:

1. A fat and oil composition comprising triglycerides as a principal component and 0.1 to 9.5% by mass of sucrose fatty acid esters, which esters have an average degree of substitution ranging from 5 to 7, a content of the polyesters having 3 or more ester bonds present in the sucrose fatty acid esters of not less than 85% by mass, a content of the monoesters present therein of not more than 5% by mass and a content of the diesters present therein of not more than 10% by mass on the basis of the total mass of the sucrose fatty acid esters.

2. The composition of claim 1, wherein the aliphatic carboxylic acids constituting the sucrose fatty acid esters are one having 2 to 22 carbon atoms.

3. The composition of claim 1, wherein the aliphatic carboxylic acids constituting the sucrose fatty acid esters comprise 0.1 to 50% by mass of saturated aliphatic carboxylic acids having 16 to 18 carbon atoms and 50 to 99.9% by mass of unsaturated aliphatic carboxylic acids having 18 to 22 carbon atoms.

4. The composition of claim 1, wherein the sucrose fatty acid esters comprise sucrose fatty acid esters comprising unsaturated aliphatic carboxylic acids in an amount of not less than 70% by mass of the total aliphatic carboxylic acids constituting the sucrose fatty acid esters; and sucrose fatty acid esters comprising saturated aliphatic carboxylic acids in an amount ranging from 40 to 80% by mass of the total aliphatic carboxylic acid constituting the sucrose fatty acid esters.

5. The composition of claim 1, wherein the rate of the sucrose fatty acid esters comprising saturated aliphatic carboxylic acids in an amount ranging from 40 to 80% by mass of the total aliphatic carboxylic acids constituting the sucrose fatty acid esters ranges from 1 to 20% by mass on the basis of the mass of the total sucrose fatty acid esters.

6. The composition of claim 1, wherein it comprises the sucrose fatty acid esters in an amount ranging from 0.5 to 2% by mass.

7. The composition of claim 1, wherein the rate of the sum of tetraesters, penta-esters, hexa-esters and hepta-esters present in the sucrose fatty acid esters is not less than 60% by mass on the basis of the total mass of the sucrose fatty acid esters.

8. The composition of claim 1, wherein all of the sucrose fatty acid esters have an HLB value of not less than 0 and less than 3.

9. The composition of claim 1, wherein it comprises a vegetable oil such as soybean oil, rapeseed oil, sunflower oil, safflower oil, linseed oil, palm oil, rice oil and corn oil, middle chain fatty acid triglycerides, or mixed oils thereof, hydrogenated oils, fractionated oils, or oils subjected to transesterification-treatments.

10. The composition of claim 1, wherein it further comprises an antioxidant.
